(19) United States
(12) Patent Application Publication
(10) Pub. No.: US 2017/0065389 A1
(43) Pub. Date: Mar. 9, 2017

(54) Oral Care System

(71) Applicant: COLGATE-PALMOLIVE COMPANY, New York, NY (US)

(72) Inventors: Kelly Gail DUNCAN, Washington, NJ (US); Paul Donald CARSE, Milford, NJ (US)

(73) Assignee: COLGATE-PALMOLIVE COMPANY, New York, NY (US)

(21) Appl. No.: 15/309,182

(22) PCT Filed: May 7, 2014
(86) PCT No.: PCT/US2014/037164

§ 371 Date: Nov. 6, 2016

(51) Int. Cl. A61C 19/06; A46B 15/00; A46B 9/04

(52) U.S. Cl. CPC A61C 19/066; A46B 9/04; A46B 15/0061; A46B 2200/1066

(57) ABSTRACT

An oral care system that includes an oral care implement and a plurality of oral care strips is disclosed. The oral care implement has a handle, which has an internal cavity and a dispensing aperture forming a passageway into the internal cavity, and a head, which includes at least one oral surface engaging element. The plurality of oral care strips, which may be tooth whitening strips, are stored in the internal cavity, and each of the plurality of oral care strips includes at least one film having an oral care material applied thereto. The dispensing aperture is configured so that the plurality of oral care strips is removable from the internal cavity via the dispensing aperture.

### BACKGROUND

Oral care implements such as toothbrushes are typically used by applying toothpaste or dentifrice to a bristle section on the head of the toothbrush, followed by brushing regions of the oral cavity (e.g., the teeth or soft tissue such as the tongue and/or gums) with the bristle section. Furthermore, a growing cosmetic trend has been to supplement toothbrushing with the application of additional oral care agents to the user's oral cavity. However, conventional systems for applying oral care agents requires that the user maintain both a toothbrush and an additional kit for storing and dispensing the oral care agent into the user's oral cavity. This not only requires extra storage space in already cramped bathroom cabinets, but also requires that the user remember to use the oral care agent treatment system. Furthermore, these systems are not conveniently portable for transport and/or travel. Moreover, these known systems only apply the oral care agent onto a single tooth at a time, thereby resulting in the application of the oral care agent being a time consuming and ineffective process. These problems require a better way to deliver the oral care agents to the oral cavity and a more convenient oral care agent application system for transport and/or travel.

### BRIEF SUMMARY

Exemplary embodiments according to the present disclosure are directed to an oral care system in which an oral care implement includes a handle having an internal cavity and a dispensing aperture, and oral care strips are dispensed from the intern cavity via the dispensing aperture.

In one aspect, the invention can be a tooth whitening system comprising: an oral care implement comprising: a handle comprising an internal cavity and a dispensing aperture forming a passageway into the internal cavity; and a head comprising at least one oral surface engaging element; a plurality of tooth whitening strips stored in the internal cavity, each of the plurality of tooth whitening strips comprising at least one film having a tooth whitening composition applied thereto; and the dispensing aperture configured so that the plurality of tooth whitening strips are removable from the internal cavity via the dispensing aperture.

Optionally, or additionally, the tooth whitening system further comprises a plurality of sealed packages, each of the plurality of sealed packages containing at least one of the plurality of tooth whitening strips; the plurality of sealed packages stored in the internal cavity; and the dispensing aperture configured so that the plurality of sealed packages are removable from the internal cavity via the dispensing aperture.

Optionally, or additionally, the tooth whitening system further comprises: each of the plurality of sealed packages comprising a first package edge and a second package edge opposite the first package edge; and wherein the plurality of sealed packages are connected to one another in an edge-to-edge arrangement such that the first and second package edges of adjacent ones of the plurality of sealed packages are connected to one another along a pre-weakened line.

Optionally, the plurality of sealed packages are wrapped about one another to form a package roll.

Optionally, the dispensing aperture is configured so that the package roll is removable from the internal cavity via the dispensing aperture in roll form.

Optionally, or additionally, the dispensing aperture being in the form of an elongated slot that extends along a slot axis; the package roll having a central axis, the package roll positioned within the internal cavity so that the central axis of the package roll is substantially parallel to the slot axis; and wherein the plurality of sealed packages can be individually dispensed from the internal cavity via the elongated slot.

Optionally, the plurality of sealed packages are arranged in a stack in the internal cavity.

Optionally, or additionally, the tooth whitening system further comprises a feed mechanism in the handle for delivering a top-most one of the plurality of sealed packages in the stack to the dispensing aperture for individual dispensing therefrom.

Optionally, or additionally, the tooth whitening system further comprises an actuator for lifting a portion of the top-most one of the plurality of sealed packages in the stack from the dispensing aperture for grasping by a user.

Optionally, each of the plurality of sealed packages contains a first type of the film having a first geometry configured for application to a user's upper teeth and a second type of the film having a second geometry configured for application to a user's bottom teeth, the first and second geometries being different from one another.

Optionally, each of the plurality of tooth whitening strips comprises a substrate layer, the film removably mounted to the substrate layer so that the tooth whitening composition is between the film and the substrate layer.

Optionally, or additionally, the tooth whitening system further comprises: each of the plurality of tooth whitening strips comprising a first strip edge and a second strip edge; and wherein the plurality of tooth whitening strips are connected to one another in an edge-to-edge arrangement such the first and second strip edges of adjacent ones of the plurality of tooth whitening strips are connected to one another along a pre-weakened line.

Optionally, the plurality of tooth whitening strips are wrapped about one another to form a strip roll.

Optionally, the dispensing aperture is configured so that the strip roll is removable from the internal cavity via the dispensing aperture in roll form.

Optionally, or additionally, the tooth whitening system further comprises: the dispensing aperture being in the form of an elongated slot that extends along a slot axis; the strip roll having a central axis, the strip roll positioned within the internal cavity so that the central axis of the strip roll is substantially parallel to the slot axis; and wherein the plurality of tooth whitening strips can be individually dispensed from the internal cavity via the elongated slot.

Optionally, the oral care implement further comprises an engagement feature adjacent the elongated slot, the engagement feature of the oral care implement configured to engage the plurality of tooth whitening strips at a position adjacent the pre-weakened line between a lead-most tooth whitening strip of the plurality of tooth whitening strips and a next-in-line tooth whitening strip of the plurality of tooth whitening strips during dispensing, thereby prohibiting dispensing of the next-in-line tooth whitening strip from the dispensing aperture and causing the pre-weakened line between the lead-most tooth whitening strip and the next-in-line tooth whitening strip to tear and release the lead-most tooth whitening strip from the strip roll.

Optionally, the plurality of tooth whitening strips are arranged in a stack in the internal cavity.

Optionally, or additionally, the tooth whitening system further comprises a feed mechanism in the handle for delivering a top-most one of the plurality of tooth whitening strips in the stack to the dispensing aperture for individual dispensing therefrom.

Optionally, or additionally, the tooth whitening system further comprises an actuator for lifting a portion of the top-most one of the plurality of tooth whitening strips in the stack from the dispensing aperture for grasping by a user.

Optionally, each of the plurality of tooth whitening strips comprises only one film that comprises the first and second strip edges.

Optionally, or additionally, the tooth whitening system further comprises: the plurality of tooth whitening strips comprising first tooth whitening strips and second tooth whitening strips, the first and second tooth whitening strips arranged in an alternating manner in the edge-to-edge arrangement; each of the first tooth whitening strips comprising a first type of the film having first geometry configured for application to a user's upper teeth; each of the second tooth whitening strips having a second type of the film having a second geometry configured for application to a user's bottom teeth; and the first and second geometries being different from one another.

Optionally, each of the plurality of tooth whitening strips comprises a substrate layer, the film of each of the tooth whitening strips removably mounted to the substrate layer so that the tooth whitening composition is between the film and the substrate layer.

Optionally, or additionally, the tooth whitening system further comprises: each of the plurality of tooth whitening strips further comprising: a substrate layer that comprises the first and second strip edges; a first type of the film removably mounted to the substrate layer, the first type of the film having a first geometry configured for application to a user's upper teeth; a second type of the film removably mounted to the substrate layer, the second type of the film having a second geometry configured for application to a user's bottom teeth; and the first and second geometries being different from one another.

Optionally, each of the plurality of tooth whitening strips comprises a substrate layer that comprises the first and second strip edges, the film of each of the tooth whitening strips removably mounted to the substrate layer so that the tooth whitening composition is between the film and the substrate layer; and wherein each of the plurality of tooth whitening strips comprises only one of the film.

Optionally, or additionally, the tooth whitening system further comprises a cover alterable between: (1) a closed state in which the cover encloses the dispensing aperture; and (2) an open state in which the dispensing aperture is exposed.

Optionally, the head comprises a plurality of tooth cleaning elements.

In another aspect, the invention can be an oral care system comprising: an oral care implement comprising: a handle comprising an internal cavity and a dispensing aperture forming a passageway into the internal cavity; and a head comprising at least one oral surface engaging element; a plurality of oral care strips stored in the internal cavity, each of the plurality of oral care strips comprising: a film; an oral care material associated on the film; a first strip edge comprising a tab; and a second strip edge opposite the first strip edge, the second strip edge comprising a notch; the plurality of oral care strips connected to one another in an edge-to-edge arrangement, the first and second strip edges of adjacent ones of the plurality of oral care strips in the edge-to-edge arrangement connected to one another along a pre-weakened line so that the tab of the first strip edge nests in the notch of the second strip edge; and the dispensing aperture configured so that the plurality of oral care strips are removable from the internal cavity via the dispensing aperture.

Optionally, for each of the plurality of oral care strips, the tab is free of the oral care material. Further optionally, for each of the plurality of oral care strips, the tab corresponds to the notch in size and shape. Optionally, or additionally, each of the plurality of oral care strips further comprises: a third strip edge extending between the first and second strip edges; a fourth strip edge opposite the third strip edge, the fourth strip edge extending between the first and second strip edges; a longitudinal axis extending between the third and fourth strip edges dividing the oral care strip into a first longitudinal second and a second longitudinal section; and wherein the notch is located entirely in the second longitudinal section.

Optionally, or additionally, the oral care system further comprises: the plurality of oral care strips comprising first oral care strips and second oral care strips, the first and second oral care strips arranged in an alternating manner in the edge-to-edge arrangement; each of the first oral care strips comprising a first type of the film having first geometry; each of the second oral care strips having a second type of the film having a second geometry; and the first and second geometries being different from one another.

Optionally, each of the plurality of oral care strips further comprises a substrate layer, the film removably mounted to the substrate layer. Further optionally, for each of the plurality of oral care strips, the film of the oral care strip comprises the first and second strip edges.

Optionally, or additionally, the oral care system further comprises: each of the plurality of oral care strips further comprising; a substrate layer; a first type of the film removably mounted to the substrate layer, the first type of the film having first geometry; a second type of the film removably mounted to the substrate layer, the second type of the film having a second geometry; and the first and second geometries being different from one another.

Optionally, the plurality of oral care strips are connected to one another in the edge-to-edge arrangement and wrap about one another to form a strip roll, the strip roll positioned within the internal cavity. Further optionally, the dispensing aperture is configured so that the strip roll is removable from the internal cavity via the dispensing aperture in roll form. Optionally, or additionally, the oral care system further comprises: the dispensing aperture being in the form of an elongated slot that extends along a slot axis; the strip roll having a central axis, the strip roll positioned within the internal cavity so that the central axis of the strip roll is substantially parallel to the slot axis; the strip roll positioned within the internal cavity so that for each of the plurality of oral care strips the first edge is a lead edge during dispensing; and wherein the plurality of oral care strips can be individually dispensed from the internal cavity via the elongated slot.

Optionally, the oral care implement further comprises an engagement feature adjacent the elongated slot, the engagement feature of the oral care implement configured to engage the plurality of oral care strips at a position adjacent the pre-weakened line between a lead-most oral care strip of the plurality of oral care strips and a next-in-line oral care strip of the plurality of oral care strips during dispensing, thereby prohibiting dispensing of the next-in-line oral care strip from the dispensing aperture and causing the pre-weakened line between the lead-most oral care strip and the next-in-line oral care strip to tear and release the lead-most oral care strip from the strip roll.

Optionally, the plurality of oral care strips are arranged in a stack in the internal cavity.

Optionally, or additionally, the oral care system further comprises a feed mechanism in the handle for delivering a top-most one of the plurality of oral care strips in the stack to the dispensing aperture for individual dispensing therefrom.

Optionally, or additionally, the oral care system further comprises an actuator for lifting a portion of the top-most one of the plurality of oral care strips in the stack from the dispensing aperture for grasping by a user.

Optionally, the oral care material is selected from a group consisting of a tooth whitening composition and a tooth anti-sensitivity composition.

In yet another aspect, the invention can be a refill for an oral care system comprising: a plurality of oral care strips, each of the plurality of oral care strips comprising: a film; an oral care material on the film; a first strip edge comprising a tab; and a second strip edge opposite the first strip edge, the second strip edge comprising a notch; and the plurality of oral care strips connected to one another in an edge-to-edge arrangement, the first and second strip edges of adjacent ones of the plurality of oral care strips in the edge-to-edge arrangement connected to one another along a pre-weakened line so that tab of the first strip edge nests in the notch of the second strip edge.

Optionally, the plurality of oral care strips are connected to one another in the edge-to-edge arrangement and wrap about one another to form a strip roll. Alternatively or additionally, the plurality of oral care strips are arranged in an accordion stack.

Optionally, the refill further comprises a sealed package, the plurality of oral care strips located within the sealed package.

In yet another aspect, the invention can be a refill for a tooth whitening system comprising: a plurality of tooth whitening strips, each of the plurality of tooth whitening strips comprising: at least one film having a tooth whitening composition applied thereto; a first strip edge; and a second strip edge and the plurality of tooth whitening strips connected to one another in an edge-to-edge arrangement, the first and second strip edges of adjacent ones of the plurality of tooth whitening strips in the edge-to-edge arrangement connected to one another along a pre-weakened line.

Optionally, the plurality of tooth whitening strips are connected to one another in the edge-to-edge arrangement and wrap about one another to form a strip roll. Alternatively or additionally, the plurality of tooth whitening strips are arranged in an accordion stack.

Optionally, the refill further comprises a sealed package, the plurality of tooth whitening strips located within the sealed package.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a first embodiment of an oral care instrument which dispenses oral care strips stored in an internal cavity of the handle;

FIG. 2 shows the embodiment of FIG. 1 with a cover member detached from the handle;

FIG. 3 is a top plan view of an embodiment of a sealed package containing an oral care strip;

FIG. 4 is a sectional view of the sealed package along the line IV-IV of FIG. 3;

FIG. 5 is a top plan view of the sealed package of FIG. 4 as the package opened for removal of the oral care strip contained within;

FIG. 6 is a top plan view of an embodiment of an oral care strip;

FIG. 7 is a top plan view of a plurality of oral care strips connected to one another in an edge-to-edge arrangement;

FIG. 8 is a side view of the connected oral care strips of FIG. 7 in an accordion arrangement;

FIG. 9 is a perspective view of the connected oral care strips of FIG. 7 wrapped about one another to form a strip roll;

FIG. 10 is a perspective view of a second embodiment of an oral care instrument which dispenses oral care strips stored in an internal cavity of the handle, shown with a cover member detached from the handle;

FIG. 11 is a perspective view of a third embodiment of an oral care instrument which dispenses oral care strips stored in an internal cavity of the handle, shown with a cover member of the handle open so that the oral care strips may be inserted or removed;

FIG. 12 is a sectional view of a strip roll stored within the handle of the oral care instrument of FIG. 11;

FIG. 13 is a perspective view of a fourth embodiment of an oral care instrument which dispenses oral care strips stored in an internal cavity of the handle;

FIG. 14 is a perspective view of the oral care instrument of FIG. 13, shown with an oral care strip being dispensed from the internal cavity;

FIG. 15 is a perspective view of the oral care instrument of FIG. 13, shown with a cover member of the handle open so that the oral care strips may be inserted or removed;

FIG. 16 is a sectional view of a strip roll stored within the handle of the oral care instrument of FIG. 13, with one of the oral care strips being dispensed from the internal cavity;

FIG. 17 is a perspective view of a fifth embodiment of an oral care instrument which dispenses oral care strips stored in an internal cavity of the handle;

FIG. 18 is a perspective view of the oral care instrument of FIG. 17, illustrating the action which presents an oral care strip to a user for dispensation;

FIG. 19 is a perspective view of the oral care instrument of FIG. 17, shown with an oral care strip being dispensed from the internal cavity;

FIG. 20 is a sectional view of the oral care instrument along the lines XX-XX of FIG. 18;

FIG. 21 is a sectional view of the oral care instrument along the lines XXI-XXI of FIG. 19;

FIG. 22 is a perspective view of a sixth embodiment of an oral care instrument which dispenses oral care strips stored in an internal cavity of the handle;

FIG. 23 is a perspective view of the oral care instrument of FIG. 22, shown with an oral care strip being dispensed from the internal cavity;

FIG. 24 is a partial sectional view of the oral care instrument along the lines XXIV-XXIV of FIG. 23;

FIG. 25 is a top plan view of a second embodiment of an oral care strip;

FIG. 26 is a sectional view of the oral care strip along the lines XXVI-XXVI of FIG. 25;

FIG. 27 is a sectional view of the oral care strip along the lines XXVII-XXVII of FIG. 25;

FIG. 28 is a top plan view of a second embodiment of an oral care strip;

FIG. 29 is a top plan view of a third embodiment of an oral care strip;

FIG. 30 is a side view of the connected oral care strips of FIG. 28 in an accordion arrangement;

FIG. 31 is a perspective view of the connected oral care strips of FIG. 28 wrapped about one another to form a strip roll;

FIG. 32 is a perspective view of the roll of oral care strips of FIG. 31, shown with one of the oral care strips being removed from the roll;

FIG. 33 is a perspective view of a seventh embodiment of an oral care instrument which dispenses oral care strips stored in an internal cavity of the handle;

FIG. 34 is a perspective view of the oral care instrument of FIG. 33, shown with an oral care strip being dispensed from the internal cavity;

FIG. 35 is a top plan view of an third embodiment of an oral care strip;

FIG. 36 is a sectional view of the oral care strip along the lines XXXVI-XXXVI of FIG. 35; and

FIG. 37 is a top plan view of a fourth embodiment of an oral care strip.

### DETAILED DESCRIPTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of the exemplary embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and similar refer to a relationship wherein structures are secured or attached to one another either directly or indirectly through intervening structures, as well as both movable or rigid attachments or relationships, unless expressly described otherwise. Moreover, the features and benefits of the invention are described by reference to the exemplary embodiments illustrated herein. Accordingly, the invention expressly should not be limited to such exemplary embodiments, even if indicated as being preferred. The discussion herein describes and illustrates some possible non-limiting combinations of features that may exist alone or in other combinations of features. The scope of the invention is defined by the claims appended hereto.

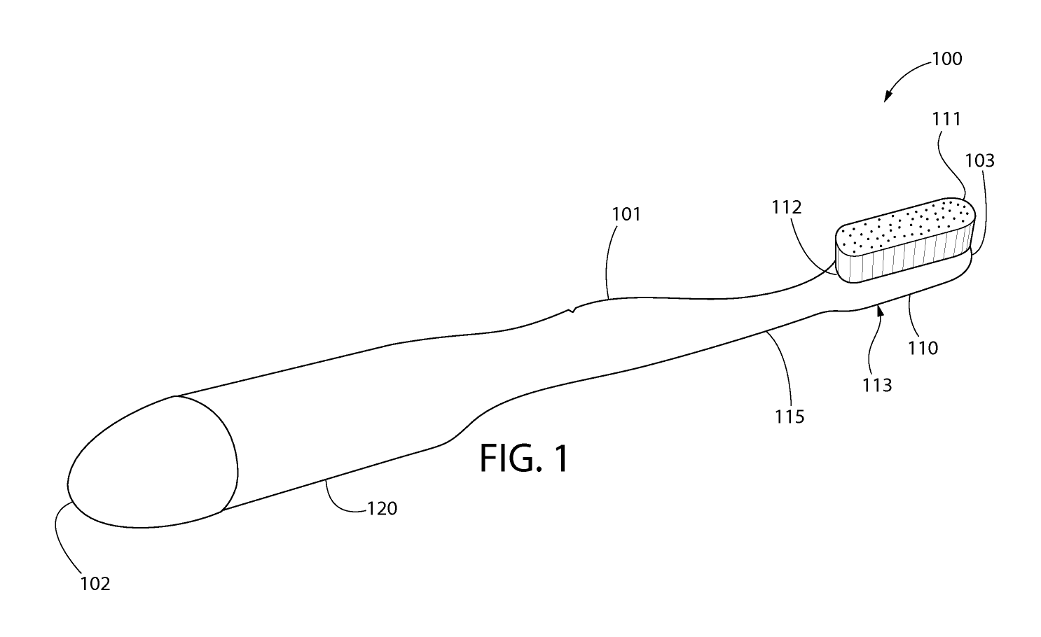

Referring first to FIG. 1, an oral care implement 100 is illustrated in accordance with an embodiment of the present invention. In this embodiment, the oral care implement 100 is in the form of a manual toothbrush. However, in other embodiments the oral care implement 100 may take on other forms such as being a powered toothbrush, a tongue scraper, a gum and soft tissue cleanser, a water pick, an interdental device, a tooth polisher, a specially designed ansate implement having tooth engaging elements or any other type of implement that is commonly used for oral care. Thus, it is to be understood that the inventive concepts discussed herein can be applied to any type of oral care implement unless a specific type of oral care implement is specified in the claims.

The oral care implement extends from a proximal end 103 to a distal end 102, generally including an elongated body 101 comprising a head 110, a neck 115 and a handle 120. The handle 120 is an elongated structure that provides the mechanism by which the user can hold and manipulate the oral care implement 100 during use. In the embodiment shown, the handle 120 is generically depicted without contours, although such contours may be incorporated into the exterior surface of the handle 120 for user comfort. Of course, in other embodiments the handle 120 may take on a wide variety of shapes, contours and configurations, none of which are limiting of the present invention unless so specified in the claims.

In the embodiment shown, the handle 120 is formed of a rigid plastic material, such as for example without limitation polymers and copolymers of ethylene, propylene, butadiene, vinyl compounds and polyesters such as polyethylene terephthalate. Of course, the invention is not to be so limited in all embodiments and the handle 120 may include a resilient material, such as a thermoplastic elastomer, as a grip cover that is molded over portions of or the entirety of the handle 120 to enhance the gripability of the handle 120 during use. For example, portions of the handle 120 that are typically gripped by a user's palm during use may be overmolded with a thermoplastic elastomer or other resilient material to further increase comfort to a user.

The head 110 of the oral care implement 100 is coupled to the handle 120 and comprises a front surface 112 and an opposing rear surface 113. In the embodiment shown, the head 110 is formed integrally with the handle 120 as a single unitary structure using a molding, milling, machining or other suitable process. However, in other embodiments the handle 120 and the head 110 may be formed as separate components which are operably connected at a later stage of the manufacturing process by any suitable technique known in the art, including without limitation thermal or ultrasonic welding, a tight-fit assembly, a coupling sleeve, threaded engagement, adhesion, or fasteners.

In the embodiment shown, the head 110 of the oral care implement 100 is provided with a plurality of tooth cleaning elements 111 extending from the front surface 112. Although in the exemplified embodiment all of the tooth cleaning elements 111 appear to be the same, the invention is not to be so limited in all embodiments. For example, in certain embodiments the tooth cleaning elements 111 include at least one bristle tuft. A bristle tuft is a collection of bristles that are positioned together into a single tuft hole formed on the head 110. Each bristle tuft may include, for example without limitation, only multi-component bristles, a combination of multi-component bristles and single-component (i.e., traditional) bristles, or only single-component bristles. The exact structure, pattern, orientation and material of the tooth cleaning elements 111 is not to be limiting of the present invention unless so specified in the claims.

As used herein, the term “tooth cleaning elements” is used in a generic sense to refer to any structure that can be used to clean, polish or wipe the teeth and/or soft oral tissue (e.g. tongue, cheek, gums, etc.) through relative surface contact. Common examples of “tooth cleaning elements” include, without limitation, bristle tufts, filament bristles, fiber bristles, nylon bristles, spiral bristles, rubber bristles, elastomeric protrusions, flexible polymer protrusions, combinations thereof and/or structures containing such materials or combinations. Suitable elastomeric materials include any biocompatible resilient material suitable for uses in an oral hygiene apparatus. To provide optimum comfort as well as cleaning benefits, the elastomeric material of the tooth or soft tissue engaging elements has a hardness property in the range of A8 to A25 Shore hardness. One suitable elastomeric material is styrene-ethylene/butylene-styrene block copolymer (SEBS) manufactured by GLS Corporation. Nevertheless, SEBS material from other manufacturers or other materials within and outside the noted hardness range could be used.

The tooth cleaning elements 111 of the present invention can be connected to the head 110 in any manner known in the art. For example, staples/anchors, in-mold tufting (IMT) or anchor free tufting (AFT) could be used to mount the cleaning elements/tooth engaging elements. In certain embodiments, the invention can be practiced with various combinations of stapled, IMT or AFT bristles. In AFT, a plate or membrane is secured to the brush head such as by ultrasonic welding. The bristles extend through the plate or membrane. The free ends of the bristles on one side of the plate or membrane perform the cleaning function. The ends of the bristles on the other side of the plate or membrane are melted together by heat to be anchored in place. Any suitable form of cleaning elements may be used in the broad practice of this invention. Alternatively, the bristles could be mounted to tuft blocks or sections by extending through suitable openings in the tuft blocks so that the base of the bristles is mounted within or below the tuft block.

In the embodiment shown, the head 110 of the oral care implement 100 includes a plurality of tuft holes (not visible) formed therein. A plurality of tufts of bristles are positioned within and affixed to the head 110 within each of the tuft holes. Each of the tufts of bristles includes a plurality of bristles, which can be single strand bristles, double strand multi-component bristles, triple strand multi-component bristles, etc. or various combinations thereof. Thus, each tuft of bristles may include only single strand bristles, or only double strand multi-component bristles, or only triple strand multi-component bristles, or any combination of single strand bristles, double strand multi-component bristles, and triple strand multi-component bristles. Additionally, a single tuft hole may be filled with an elastomeric cleaning element or any of the other types of cleaning elements noted above.

Although not illustrated herein, in certain embodiments the head 110 may also include a soft tissue cleanser coupled to or positioned on the rear surface 113. An example of a suitable soft tissue cleanser that may be used with the present invention and positioned on the rear surface of the head 110 is disclosed in U.S. Pat. No. 7,143,462, issued Dec. 5, 2006 to the assignee of the present application, the entirety of which is hereby incorporated by reference. In certain other embodiments, the soft tissue cleanser may include protuberances, which can take the form of elongated ridges, nubs, or combinations thereof. Of course, the invention is not to be so limited and in certain embodiments the oral care implement 100 may not include any soft tissue cleanser.

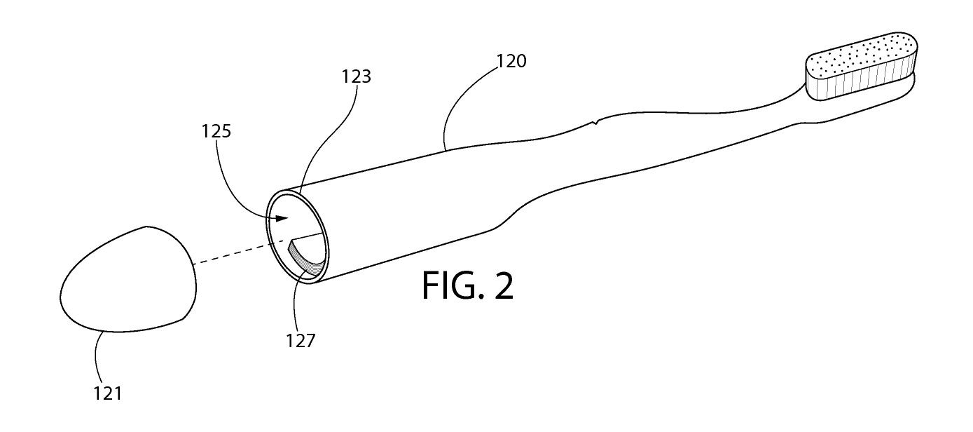

In the embodiment shown, the handle 120 at the distal end 102 of the oral care implement 100 includes a cap 121 which is removable. As seen in FIG. 2, the cap 121 affixes to the remaining portion of the handle 120 to cover a dispensing aperture 123 formed in the distal end 102. When the cap 121 is affixed to the handle 120, it encloses an internal cavity 125 of the handle 120. When the cap 121 is removed from the handle 120, the dispensing aperture 123 forms a passageway into the internal cavity 125. In the embodiment shown, a plurality of sealed packages 127, each containing at least one oral care strip, are stored within the internal cavity 125. In addition, the dispensing aperture 123 has a size and shape which permits the plurality of sealed packages 127 to be inserted into and removed from the internal cavity 125 through the dispensing aperture 123, whether one at a time or a plurality at a time. As is detailed below, in certain embodiments the handle 120 may include a loading aperture that is different from the dispensing aperture 123.

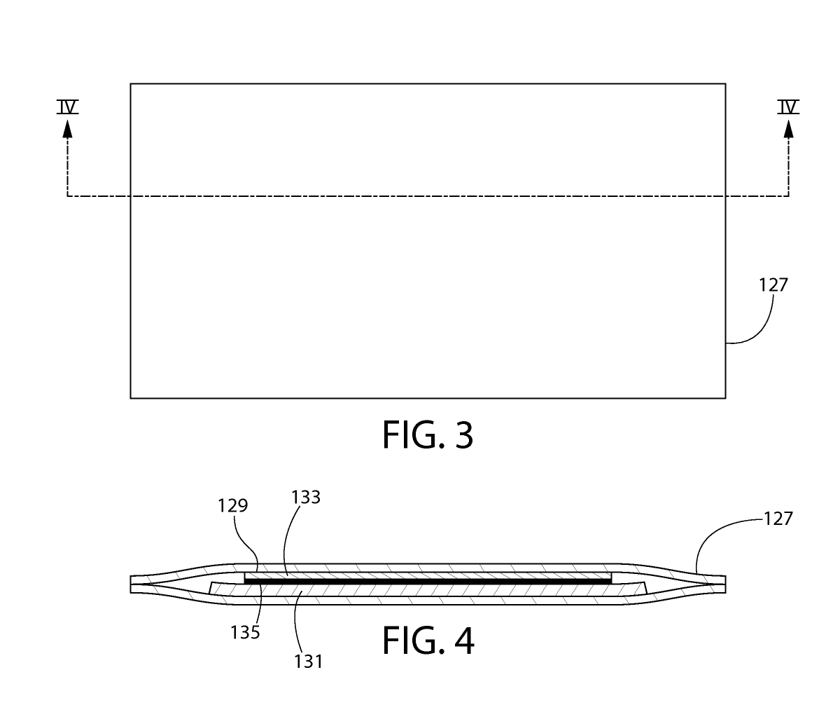

A sealed package 127 containing oral care strips 129 is shown in FIGS. 3-5. In the embodiment shown, the sealed package 127 is rectangular in shape, although the exact geometry of the sealed package 127 is not to be limiting of the present invention unless so specified in the claims. In certain embodiments, the sealed package 127 is hermetically sealed against incursion from external fluids and gases. The oral care strips 129 include a substrate layer 131 to which a film 133 is affixed, with an oral care composition 135 disposed between the film 133 and the substrate layer 131. As is known in the art, the oral care composition 135 may serve as an adhesive between the film 133 and the substrate layer 131. It is understood that the term “film” is not limited to any specific material or structure, and that in some embodiments it includes materials such as a non-woven or any other material that is appropriate for the intended application. In certain embodiments, the adhesive (or oral care composition 135) used to affix the film 133 to the substrate layer 131 also functions as an adhesive to keep the film on a user's teeth when the film is placed thereon. In certain embodiments, an inner surface of the sealed package 127 may act as the substrate layer 131, with the side of the film 133 having the oral care composition 133 facing the inner surface of the sealed package 127. In certain embodiments, the oral care strips 129 may not include the oral care composition 135, with the user adding a desired oral care composition after the oral care strip 129 is removed from the internal cavity. Therefore, the inclusion of the oral care composition on the oral care strip is not to be limiting of the present invention unless so specified in the claims.

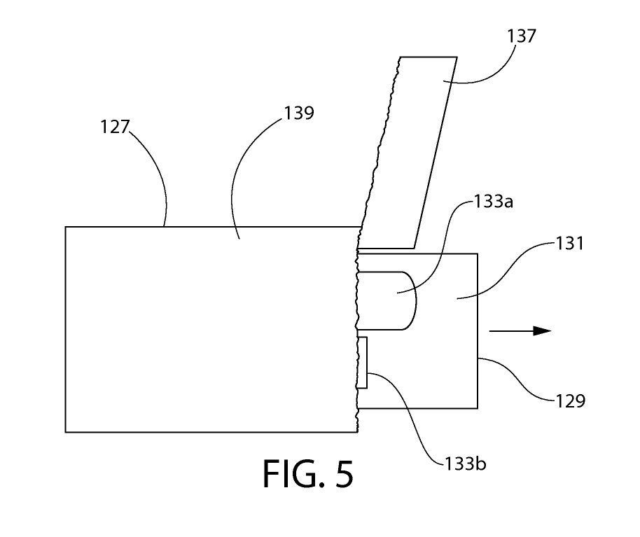

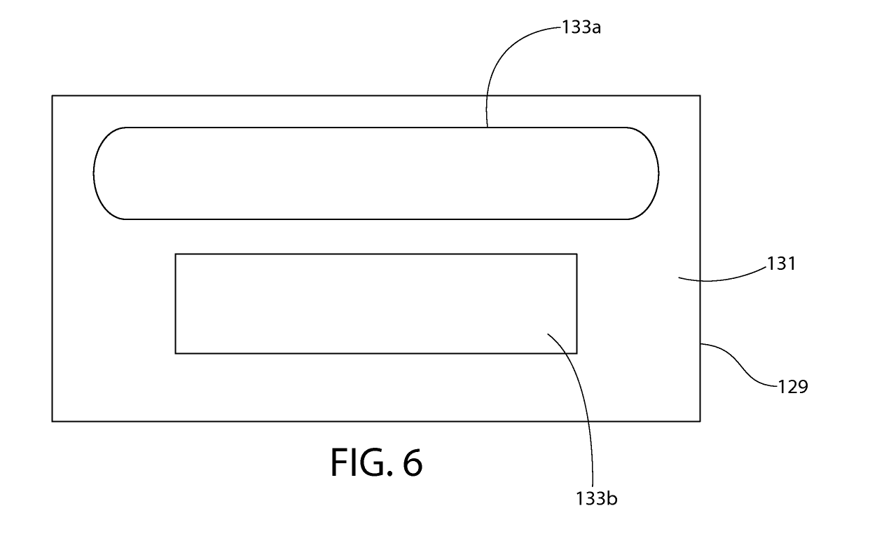

As shown in FIG. 5, the oral care strips 129 may be removed from the sealed package 127 by tearing or otherwise separating one end 137 of the sealed package 127 from a larger portion 139 of the sealed package 127. The separation may be facilitated by a perforation, in the sealed package 127, the choice of material for the sealed package 127, or by any suitable technique known in the art that enables a user to access the oral care strips 129 within the sealed package 127. As is shown more clearly in FIG. 6, the substrate layer 131 has two films 133a, 133b affixed thereto. The first film 133a is formed having a first geometry, and the second film 133b is formed having a second geometry, with the first and second geometries being different from one another in one or both of size and shape. In certain embodiments, the geometries of the two films 133a, 133b may be identical. Where oral care strips of different geometries are included, one of the geometries may be configured for application to a user's upper teeth, and the other of the geometries may be configured for application to a user's bottom teeth.

The oral care composition may include one or both of a teeth whitening composition or a desensitizing composition. One example of a teeth whitening strip is disclosed in U.S. Pat. No. 6,419,906, issued Jul. 16, 2002 to the assignee of the present application, the entirety of which is hereby incorporated by reference. As discussed therein, the whitening strip (i.e., the film with the included teeth whitening composition) is applied to the surface of the teeth, at which point the composition is hydrated by salvia in the oral cavity. Alternatively, the composition may be pre-wetted by dipping the film into water. As another alternative, the teeth whitening composition may be in liquid form. Likewise, the desensitizing composition may be in solid form, to be hydrated by saliva or by dipping in water, or it may be in liquid form. In certain embodiments where both a teeth whitening composition and a desensitizing composition are included, the two compositions are preferably in the same form (i.e., a dry state or a wet state) on the film while it is stored within the package.

The film is formed to have a width dimension suitable to cover a row of teeth (upper or lower). Therefore, the oral care strip may be applied to the upper set of teeth, or to the lower set of teeth either separately or simultaneously. The length dimension of the oral care strip is determined by the amount of coverage desired. In this regard, the number of teeth to which it is desired to apply the composition will determine the dimensions of the oral care strip. For instance, it may be desired to only apply a teeth whitening composition to the front teeth, which are most easily seen by others. Accordingly, the length of a whitening strip can be reduced in this case, as compared to the case where it is desired to whiten all of the teeth. The duration of application of whitening strip to the teeth will depend upon the type and concentration of the whitening agent, as well as the type and intensity of stain.

In certain embodiments, solid whitening compositions may be employed, and some sutable solid whitening compositions include peroxides, metal chlorites, perborates, percarbonates, peroxyacids, persulfates, and combinations thereof. Suitable peroxide compounds include hydrogen peroxide, urea peroxide, calcium peroxide, and mixtures thereof. Suitable metal chlorites include calcium chlorite, barium chlorite, magnesium chlorite, lithium chlorite, sodium chlorite, and potassium chlorite.

In certain embodiments, the desensitizing composition may be solid compositions, and some suitable desensitizing compositions include potassium nitrate, other potassium salts, citric acid, citrates, strontium chloride, sodium fluoride, and stannous fluoride, such as are known in the art.

In still other embodiments, different oral care materials can be utilized with the present invention. Contemplated oral care materials include without limitation, antibacterial agents; oxidative or whitening agents; enamel strengthening or repair agents; tooth erosion preventing agents; tooth sensitivity ingredients; gum health actives; nutritional ingredients; tartar control or anti-stain ingredients; enzymes; sensate ingredients; flavors or flavor ingredients; breath freshening ingredients; oral malodor reducing agents; anti-attachment agents or sealants; diagnostic solutions; occluding agents, dry mouth relief ingredients; catalysts to enhance the activity of any of these agents; colorants or aesthetic ingredients; and combinations thereof. Although in some embodiments the oral care material may be a dentifrice, the oral care material is preferably free of (i.e., is not) dentifrice in some other embodiments. Instead, in such embodiments the oral care material is intended to provide benefits in addition to merely brushing one's teeth. Other suitable oral care materials could include lip balm or other materials that are typically available in a semi-solid state. Furthermore, in still other embodiments the oral care material can be a natural ingredient, such as for example without limitation, lotus seed; lotus flower, bamboo salt; jasmine; corn mint; camellia; aloe; gingko; tea tree oil; xylitol; sea salt; vitamin C; ginger; cactus; baking soda; pine tree salt; green tea; white pearl; black pearl; charcoal powder; nephrite or jade and Ag/Au+.

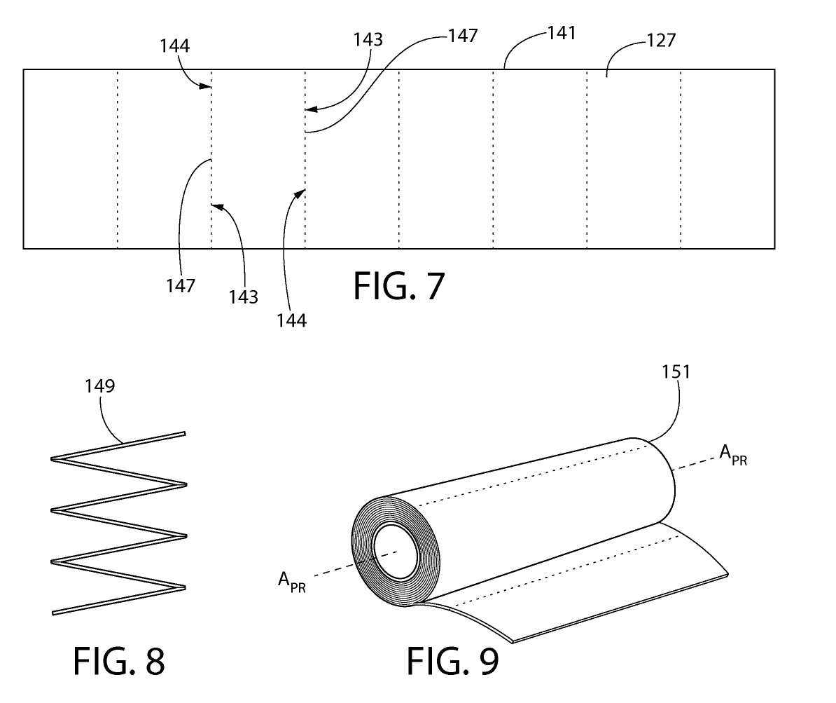

A plurality of sealed packages 127 connected to one another in an edge-to-edge arrangement 141 are shown in FIG. 7. Each sealed package 127 has a first package edge 143 and a second package edge 145 opposite the first package edge 143. The sealed packages 127 are connected in the edge-to-edge arrangement 141 such that the first package edge 143 of one sealed package 127 is connected to the second package edge 145 of a second, adjacent sealed package 127 along a pre-weakened line 147. The pre-weakened line may be formed by perforations, thinned material, or by any suitable technique known in the art that facilitates separating one package form an adjacent package.

In FIG. 8, the edge-to-edge arrangement 141 of sealed packages 127 is shown in an accordion-style fold arrangement 149 which is suitable for use in certain embodiments of the oral care implement 100. In FIG. 9, the edge-to-edge arrangement 141 of sealed packages 127 is shown in a roll form, such that the plurality of sealed packages are wrapped about one another to form a package roll 151. The package roll 151 has a central axis, A_{PR}, about which the package roll 151 may rotate when one or more of the packages are being drawn away from the package roll 151.

Both the accordion-style fold arrangement 149 of FIG. 8 and the package roll 151 of FIG. 9 may be used as a refill for an oral care implement after the oral care strips of the oral care implement have been consumed by the user.

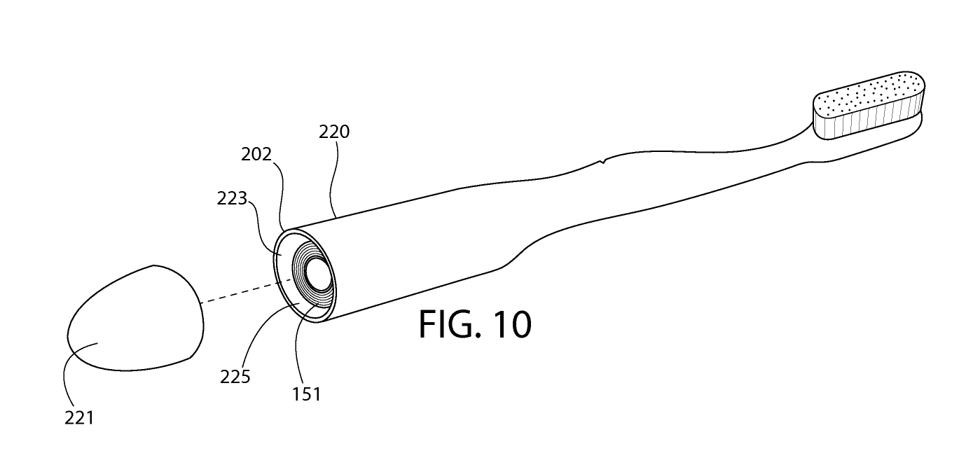

In the embodiment shown in FIG. 10, the handle 220 at the distal end 202 of the oral care implement 200 includes a cap 221 which is removable. The cap 221 affixes to a dispensing aperture 223 formed in the distal end 202, and when the cap 221 is affixed to the handle 220, it encloses an internal cavity 225 of the handle 220. When the cap 221 is removed from the handle 220, the dispensing aperture 223 forms a passageway into the internal cavity 225. In the embodiment shown, a package roll 151 is stored within the internal cavity 225, and the dispensing aperture 223 has a size and shape which permits the package roll 151 to be inserted into and removed from the internal cavity 225 in roll form.

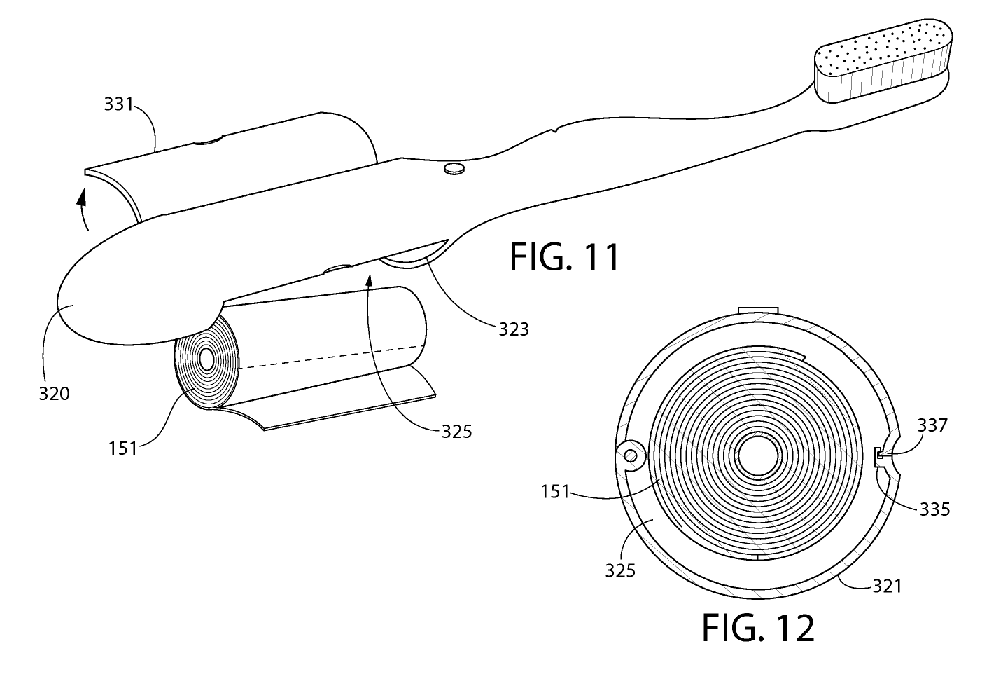

In the embodiment shown in FIGS. 11-12, the handle 320 includes a hinged door 331 which opens to create a dispensing aperture 323, and the dispensing aperture 323 forms a passageway into the internal cavity 325 of the handle 320. A package roll 151 may be stored within the internal cavity 325, as shown in FIG. 12. The dispensing aperture 323 has a size and shape which permits the package roll 151 to be inserted into and removed from the internal cavity 325 in roll form. The hinged door 331 includes a latch 335 which secures to a corresponding catch 337 within the internal cavity 325 when the hinged door 331 is in the closed position. Alternatively, the catch 337 and latch 335 may be any suitable mechanisms known in the art that enable the hinged door 331 to be secured closed and opened as needed by the user.

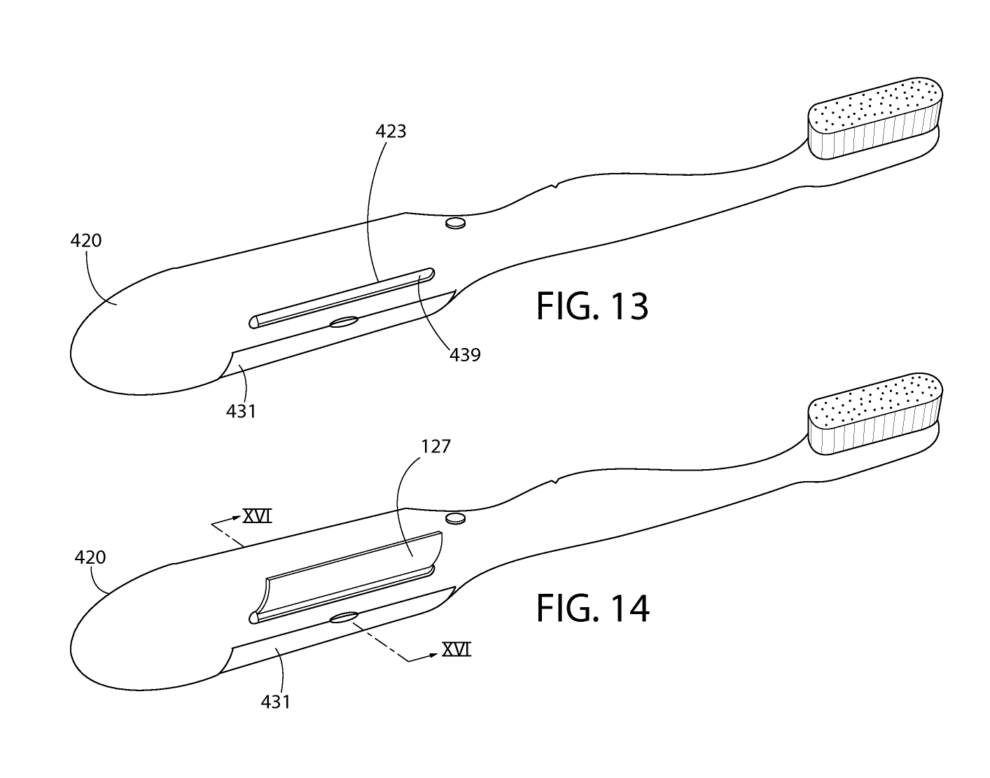

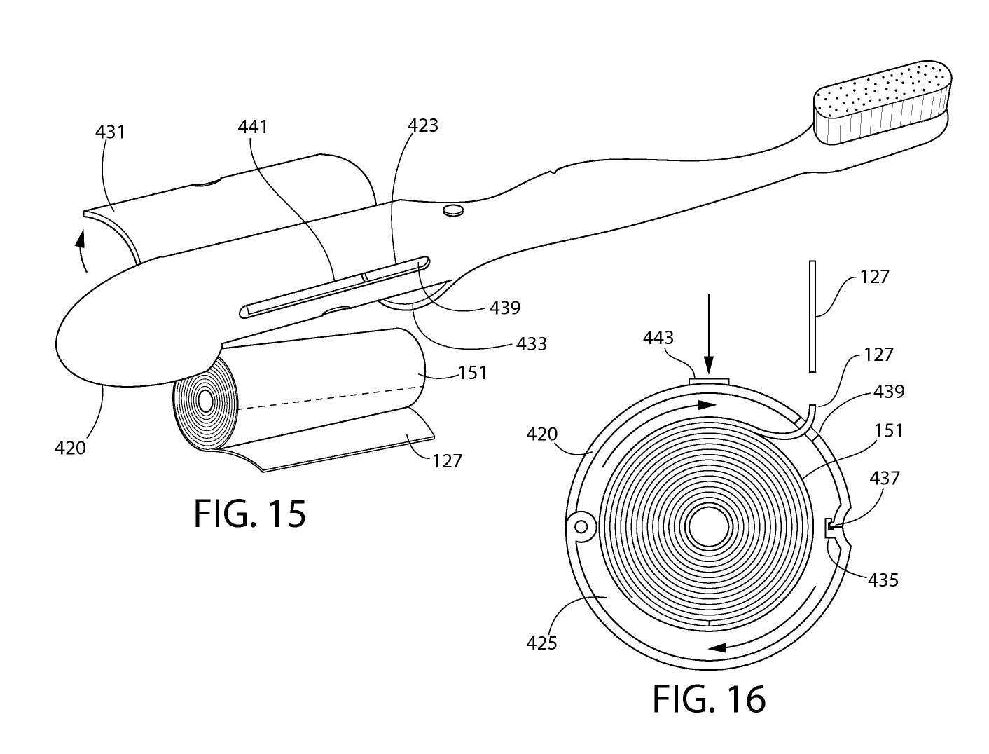

In the embodiment shown in FIGS. 13-16, the handle 420 includes a hinged door 431 which opens to create a loading aperture 433 for a package roll 151, which may be stored within the internal cavity 425, as shown in FIG. 16. The loading aperture 433 has a size and shape which permits the package roll 151 to be inserted into and removed from the internal cavity 425 in roll form. The hinged door 431 includes a latch 435 which secures to a corresponding catch 437 within the internal cavity 425 when the hinged door 431 is in the closed position. Alternatively, the catch 437 and latch 435 may be any suitable mechanisms known in the art that enable the hinged door 431 to be secured closed and opened as needed by the user. A dispensing aperture 423 is formed by an elongated slot 439, elongated sides 441 of which define a slot axis. When the package roll 151 is loaded into the internal cavity 425, the sealed package 127 at the free end of the package roll 151 feeds through the elongated slot 439 so that it may be grasped by the user. As is shown in FIG. 16, a depressible button 443 is included on the exterior of the handle 420, and this depressible button 443 is configured to actuate a rotation arresting mechanism (not shown) within the internal cavity 425. The rotation arresting mechanism serves to prevent the package roll 151 from rotating so that when a user grasps the sealed package 127 at the free end of the package roll 151, which extends through the elongated slot 439, rotational resistance is applied to the package roll 151, thereby enabling the user to detach the sealed package 127 at the free end of the package roll 151. Upon detaching the sealed package 127 at the free end of the package roll 151, the next-in-line sealed package 127 extends through the elongated slot 439 so that it may be grasped by the user.

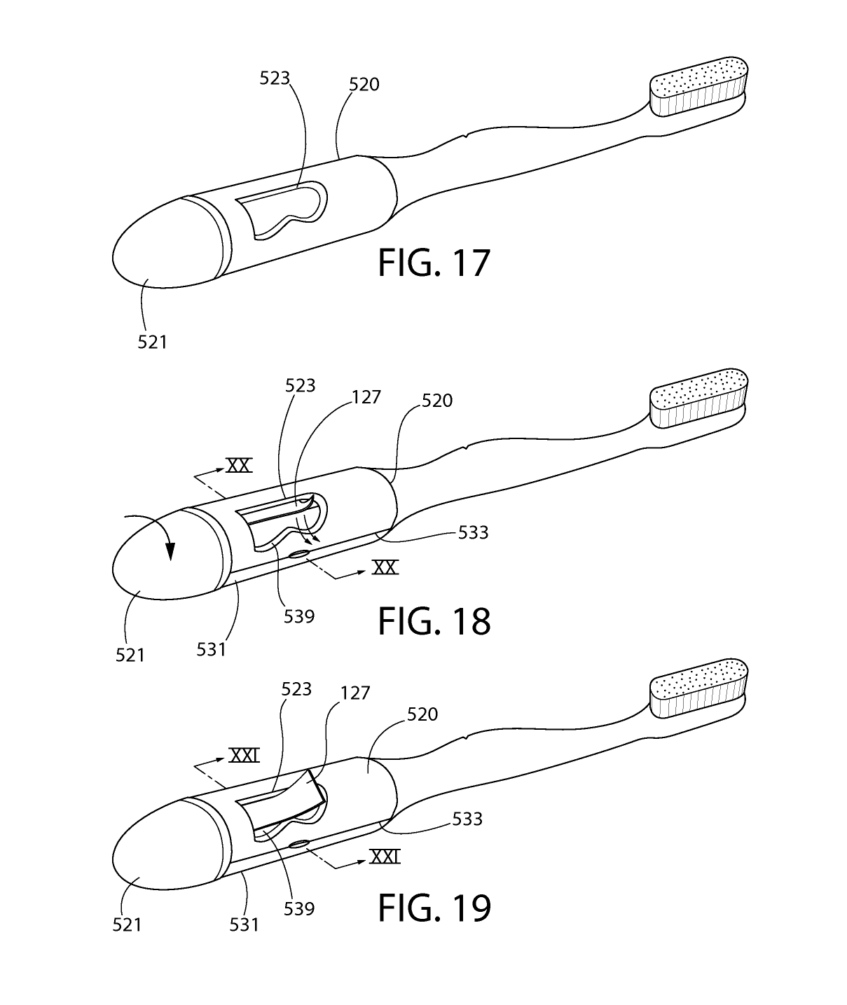

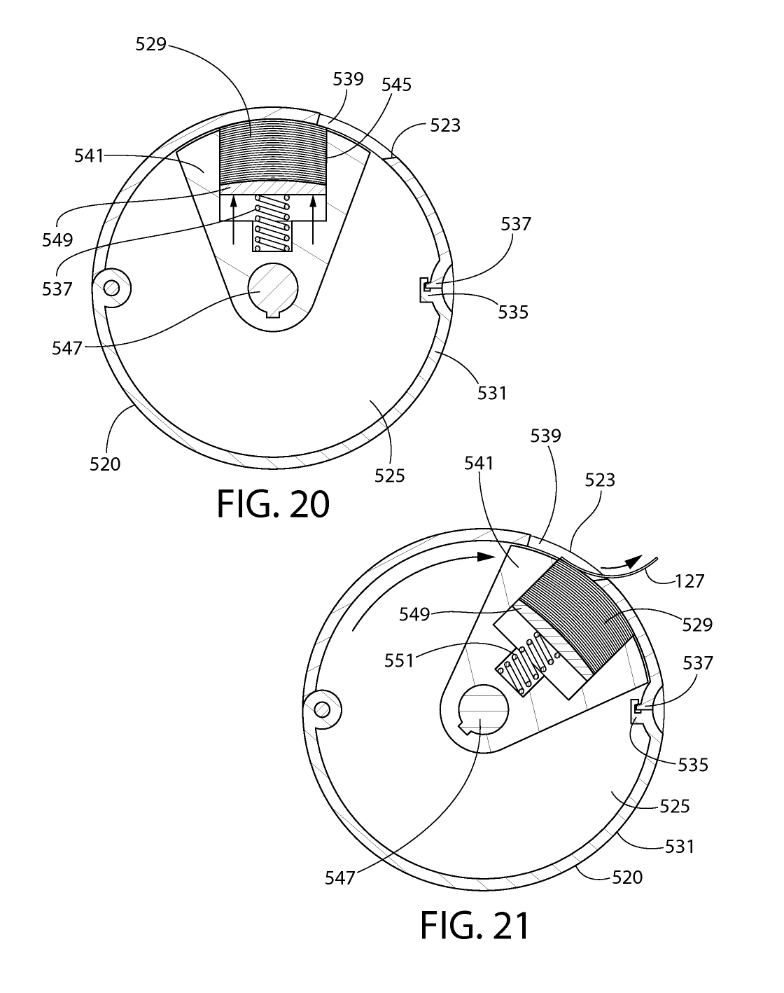

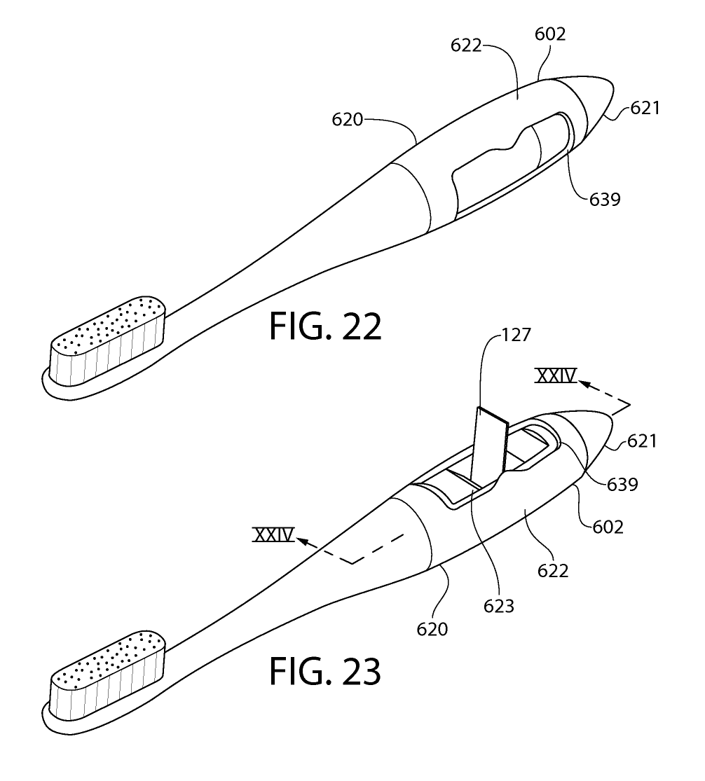

In the embodiment shown in FIGS. 17-21, a plurality of the sealed packages 127 are arranged in a stack 529 within the internal cavity 525. As shown in FIG. 20, the handle 520 includes a hinged door 531 which opens to create a loading aperture 533 for the stack 529. The hinged door 531 includes a latch 535 which secures to a corresponding catch 537 within the internal cavity 525 when the hinged door 531 is in the closed position. Alternatively, the catch 537 and latch 535 may be any suitable mechanisms known in the art that enable the hinged door 531 to be secured closed and opened as needed by the user.

A dispensing aperture 523 is formed by an opening 539 in the handle 520, and one of the plurality of the sealed packages 127 extends out through the dispensing aperture 523 so that it may be grasped by a user. The cap 521 of the handle 520 is coupled to a feed mechanism 541 located within the internal cavity 525. The cap 521 and the feed mechanism 541 rotate together, independently of the body 522 of the handle 520, between a first position in which the stack 529 is entirely enclosed within the internal cavity 525 (FIG. 20) and a second position in which the stack 529 is exposed through the dispensing aperture 523 so that the user may grasp the top-most sealed package 127 in the stack 529 (FIG. 21). The feed mechanism 541 includes feed tray 545 which rotates on an axle 547. The axle 547 is also coupled to the cap 521, so that rotation of the cap 521, relative the body 522 of the handle 520, causes the feed tray 545 to likewise rotate relative to the body 522 of the handle 520 (and also relative to the feed dispensing aperture 523). The feed tray 545 also includes a platform 549 seated on a spring 551, with the spring 551 biasing the platform 549 away from the axle 547 and toward the body 522 of the handle 520. The stack 529, which is placed on the platform 549 is therefore likewise biased toward the body 522 of the handle 520. When the cap 521 and the feed mechanism 541 are in the first position, the body of the handle 522 serves as a cover for the stack 529. As the cap 521 and feed tray 545 are rotated from the first position to the second position, to expose the stack 529 through the dispensing aperture 523, an actuator 553 formed in the periphery of the dispensing aperture 523 engages and lifts a portion of the top-most sealed package 127 so that the top-most sealed package 127 may be grasped by a user.

In the embodiment shown in FIGS. 17-21, a plurality of the sealed packages 127 are arranged in a stack 629 within the internal cavity 625. This embodiment is configured to dispense the sealed packages 127 one at a time in essentially the same way that sheets are described as being dispensed in U.S. Patent Publication No. 20030000958, published on Jan. 2, 2003, the disclosure of which is incorporated herein by reference in its entirety. Within the stack 629, one end of each sealed package 127 is lightly adhered to a first adjacent sealed package 127 and the other end of each sealed package 127 is lightly adhered to a second adjacent sealed package 127, to give the stack 629 a modified accordion arrangement.

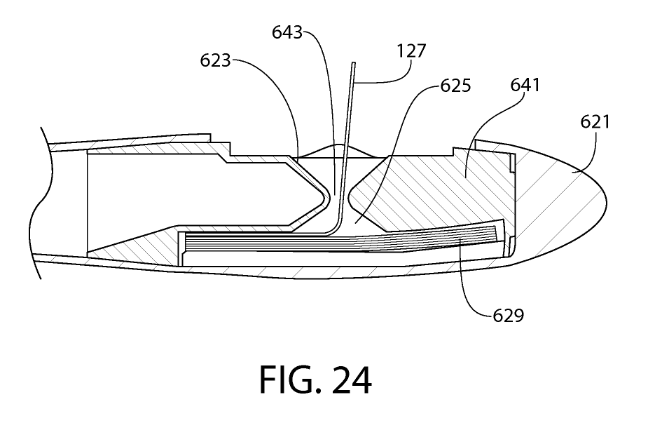

A dispensing aperture 623 is formed in an opening 639 in the handle 620, and one of the plurality of the sealed packages 127 extends out through the dispensing aperture 623 so that it may be grasped by a user. The handle 620 at the distal end 602 of the oral care implement 600 includes an cap 621 which is affixed to a dispensing cartridge 641 within the internal cavity 625. Both the cap 621 and the dispensing cartridge 641 are rotatable with respect to the body 622 of the handle 620, and the dispensing cartridge 641 includes a dispensing slot 643 through which the top-most sealed package 127 in the stack 629 extends. The cap 621 and the dispensing cartridge 641 rotate together between a first position, in which the stack 629 is entirely enclosed within the internal cavity 625 and the body 622 of the handle 620 forms a cover over the stack 529, and a second position, in which the stack 629 is exposed through the dispensing aperture 623 so that the user may grasp the top-most sealed package 127 in the stack 629 (FIG. 24). The dispensing cartridge 641 is removable from the handle 620 to reload with a new stack of sealed packages.

In the embodiments discussed above, including those for the oral care instruments, the package roll, and the package stack, all equally apply to embodiments in which the oral care strips are not enclosed in a package. For example, oral care strips may include substrates, with the substrates connected in and edge-to-edge arrangement so that the oral care strips themselves, without any packaging, are formed into a strip roll or formed into a strip stack, with pre-weakened lines between each of the substrates. Such strip rolls or strip stacks may be incorporated into any of the previously described embodiments, so that whether no embodiment is intended to be limiting of the present invention unless so specified in the claims.

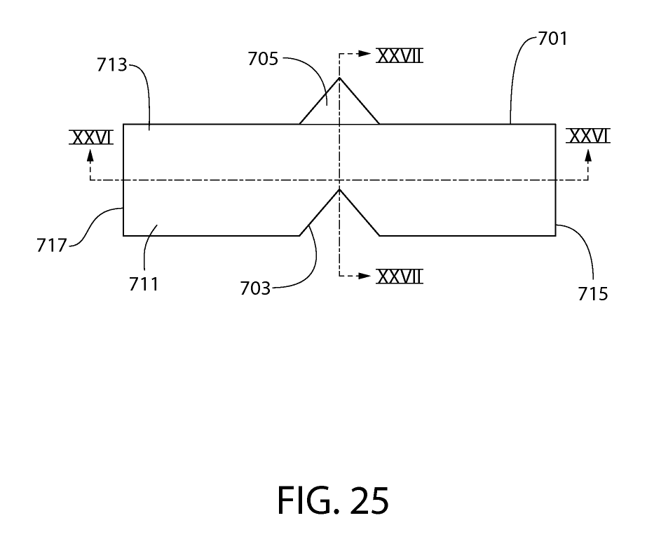

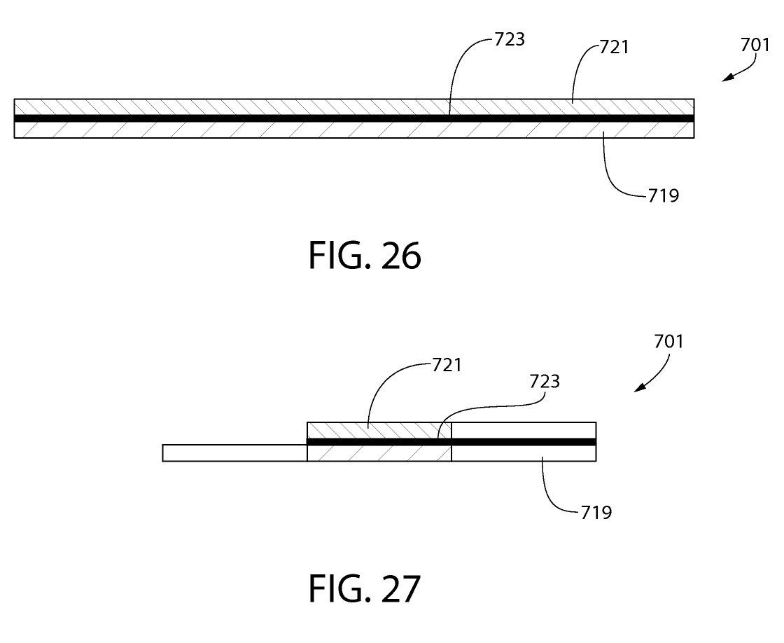

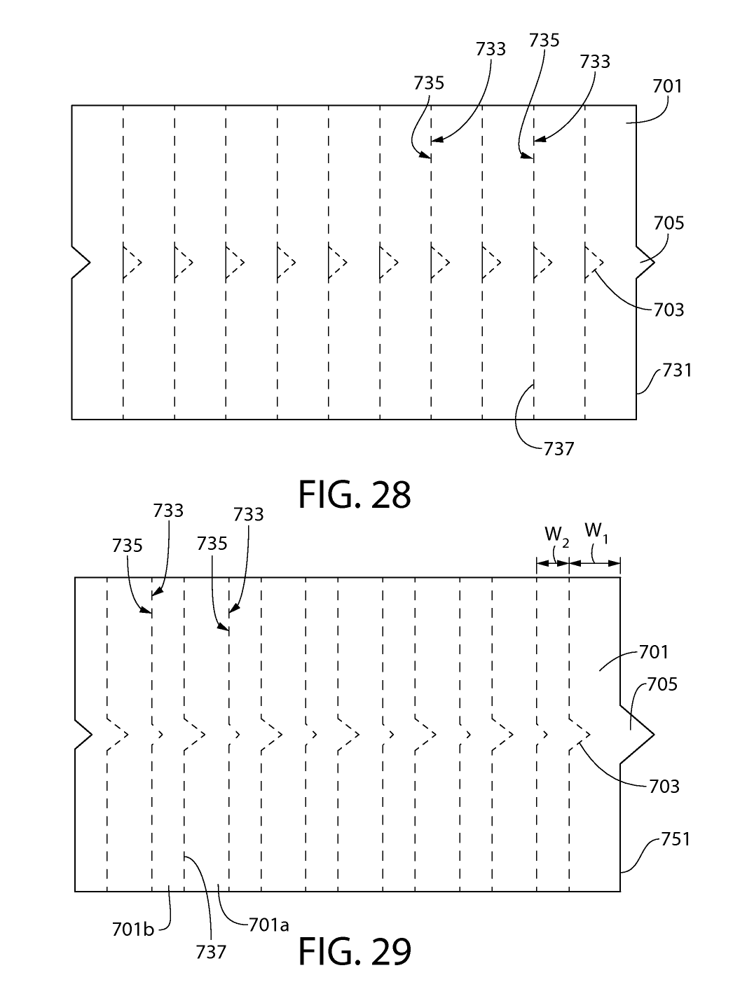

Another embodiment of an oral care strip 701 is shown in FIGS. 25-27. The oral care strip 701 is chiefly rectangular, with a notch 703 formed along one side and a corresponding tab 705 formed along the opposite side. In certain embodiments, the tab 705 and the notch 703 may complementary, with the tab 705 corresponding to the notch 703 in size and shape, so that a plurality of the oral care strips 701 may be placed in an edge-to-edge arrangement, as is shown in FIG. 28. In certain embodiments, the notch 703 may be located entirely within one longitudinal section 711 of the oral care strip 701, where the oral care strip 701 is divided into two longitudinal sections 711, 713 between the shorter edges 715, 717 of the oral care strip 701. By locating the notch 703 entirely within the one longitudinal section 711, the longitudinal section 715 without the notch may be placed on the front of a user's teeth, and the longitudinal section 711 with the notch 703 may then be folded over the biting edges of the teeth to envelope the backs of the teeth. This type of geometry aids in making the oral care strip easier to use, and it is not intended to be limiting of the present invention unless so specified in the claims.

The oral care strip 701 includes a substrate layer 719, a film 721 affixed thereto, and an oral care composition 723, with the oral care composition 723 being disposed between the film 721 and the substrate layer 719. In certain embodiments, the area that forms the tab 705 may be free of the oral care composition 723 between the film 721 and the substrate layer 719. In the embodiment shown, the area that forms the tab 705 is free of the oral care composition 723, and the film 721 does not extend over the tab 705. In certain embodiments, the oral care strip 701 may not include the oral care composition 723, with the user adding a desired oral care composition after the oral care strip is removed from the internal cavity. Therefore, the inclusion of the oral care composition 723 on the oral care strip 701 is not intended to be limiting of the present invention unless so specified in the claims.

A plurality of oral care strips 701 connected to one another in one embodiment of an edge-to-edge arrangement 731 are shown in FIG. 28. Each oral care strip 701 has a first strip edge 733 and a second strip edge 735 opposite the first strip edge 733. The oral care strips 701 are connected in the edge-to-edge arrangement 731 such that the first strip edge 733 of one oral care strip 701 is connected to the second strip edge 735 of a second, adjacent oral care strip 701 along a pre-weakened line 737. The pre-weakened line 737 may be formed by perforations, thinned material, or by any suitable technique known in the art that facilitates separating one oral care strip 701 form an adjacent oral care strip 701. In addition, the tab 705 of one oral care strip 701 nests into the notch 703 of an adjacent oral care strip 701, with the pre-weakened line 737 extending between the interface between the nested notch 703 and tab 705. In certain embodiments, only the substrate layers of the oral care strips may include the pre-weakened line, with the films of adjacent oral care strips being entirely unconnected from one another.

A plurality of oral care strips 701 connected to one another in a second embodiment of an edge-to-edge arrangement 751 are shown in FIG. 28. In this embodiment, the oral care strips 701 have one of two geometrical configurations 701a, 701b, with the first geometry exemplified by a first width, W1, and the second geometry exemplified by a second width, W2, the two widths being different from one another. The two geometries are arranged in an alternating manner in the edge-to-edge arrangement 751, with one of the geometries configured for application to a user's upper teeth, and the other of the geometries configured for application to a user's bottom teeth.

As with the first embodiment, each oral care strip 701 has a first strip edge 733 and a second strip edge 735 opposite the first strip edge 733. The oral care strips 701 are connected in the edge-to-edge arrangement 751 such that the first strip edge 733 of one oral care strip 701 is connected to the second strip edge 735 of a second, adjacent oral care strip 701 along a pre-weakened line 737. The pre-weakened line 737 may be formed by perforations, thinned material, or by any suitable technique known in the art that facilitates separating one package form an adjacent package. In addition, the tab 705 of one oral care strip 701 nests into the notch 703 of an adjacent oral care strip 701, with the pre-weakened line 737 extending between the interface between the nested notch 703 and tab 705.

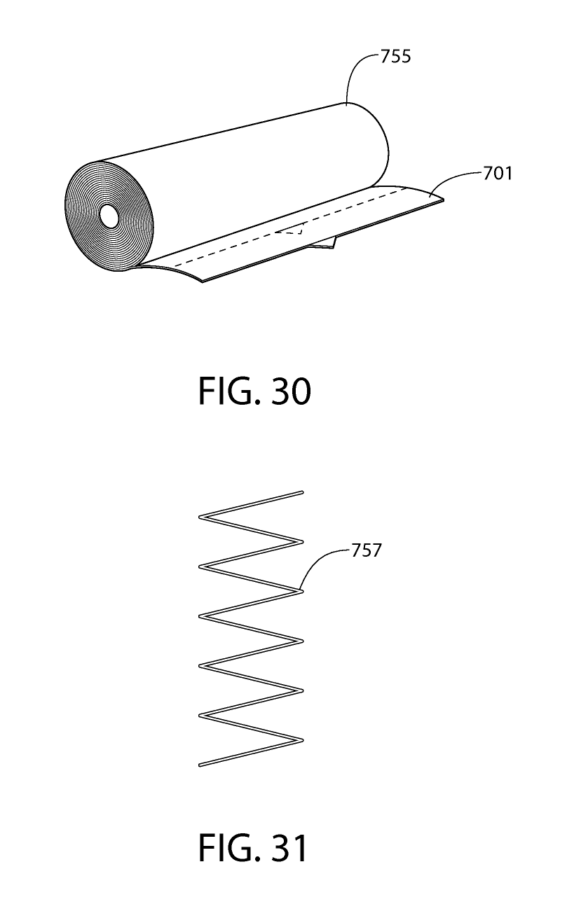

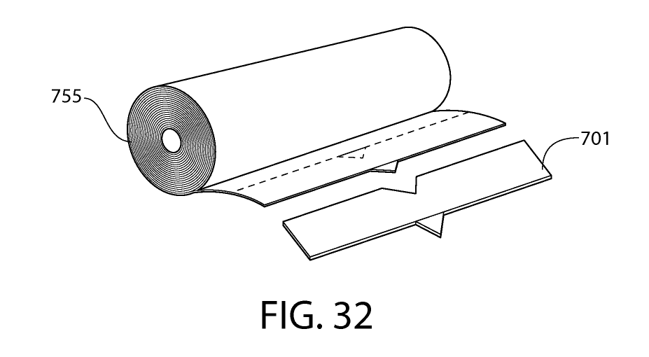

FIG. 30 illustrates that the edge-to-edge arrangements 731, 751 of either FIG. 28 or 29 may be formed in roll form, such that the plurality of oral care strips are wrapped about one another to form a strip roll 755 which is suitable for use in certain embodiments of the oral care implement. FIG. 32 illustrates the strip roll 755 as one oral care strip 701 is removed from the strip roll 755 along the pre-weakened line 737 which connected the removed oral care strip 701 to the next-in-line oral care strip 701.

FIG. 31 illustrates that the edge-to-edge arrangements 731, 751 of either FIG. 28 or 29 may be formed into an accordion-style fold arrangement 757 which is suitable for use in certain other embodiments of the oral care implement. In the case of folding the second embodiment of the edge-to-edge arrangement 751, it may be beneficial to fold the arrangement 751 at every other pre-weakened line 737 so that each layer of the accordion fold arrangement 757 has an equal width. Both the accordion-style fold arrangement 757 of FIG. 31 and the package roll 755 of FIG. 30 may be used as a refill for an oral care implement after the oral care strips of the oral care implement have been consumed by the user

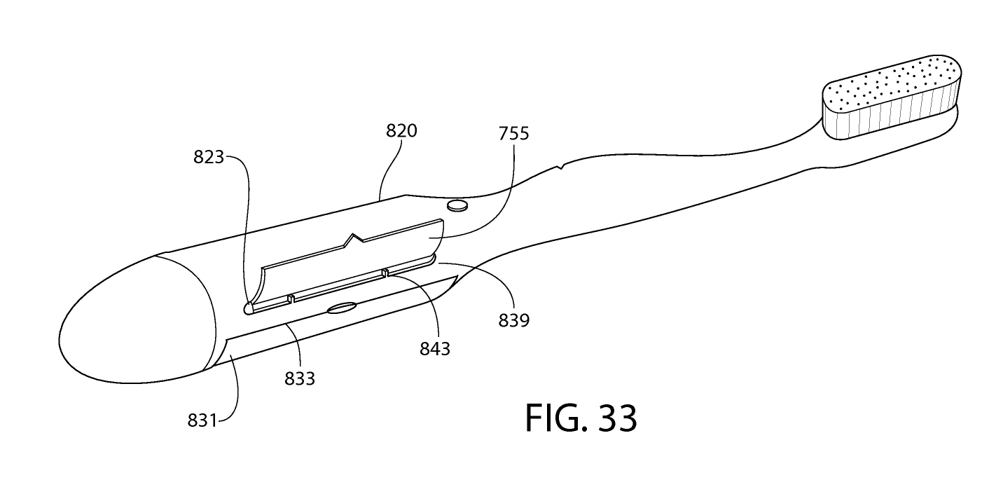

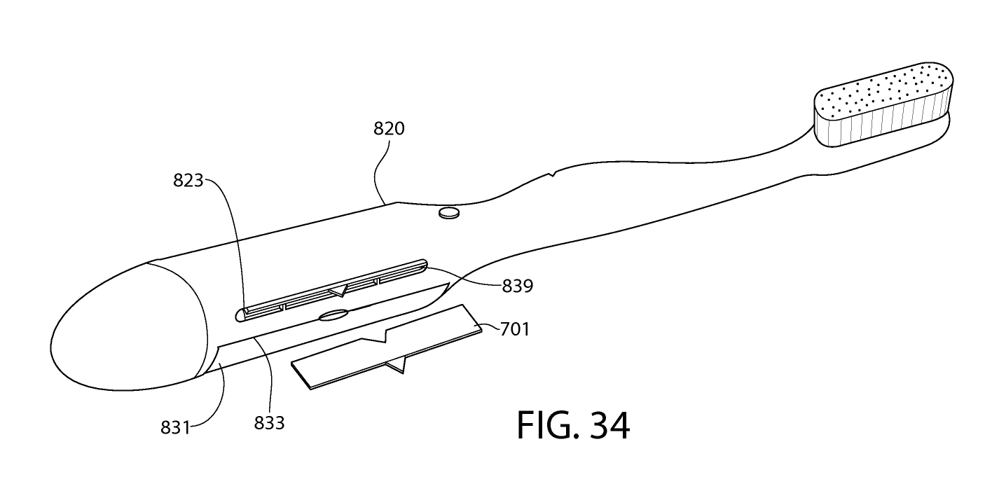

In the embodiment shown in FIGS. 33-34, the handle 820 includes a hinged door 831 which opens to create a loading aperture 833 for a strip roll 755, which may be stored within the internal cavity (not shown). The loading aperture 833 has a size and shape which permits the strip roll 755 to be inserted into and removed from the internal cavity in roll form. A dispensing aperture 823 is formed by an elongated slot 839, elongated sides 841 of which define a slot axis. One side of the elongated slot 839 includes protuberances 843 which extend into the opening of the elongated slot 839. The strip roll 755 is loaded into the internal cavity with the oral care strip 701 at the free end of the strip roll 755 feeding through the elongated slot 839 so that it may be grasped by the user. When the user grasps the oral care strip 701 at the free end of the strip roll 755 and pulls in a generally outward and downward direction, the protuberances 843 engage the pre-weakened line 737 between the oral care strip 701 at the free end of the strip roll 755 and the next-in-line oral care strip 701. This causes the pre-weakened line 737 to tear, thereby releasing the oral care strip 701 at the free end of the strip roll 755. The next-in-line oral care strip 701 then becomes the oral care strip 701 at the free end of the strip roll 755.

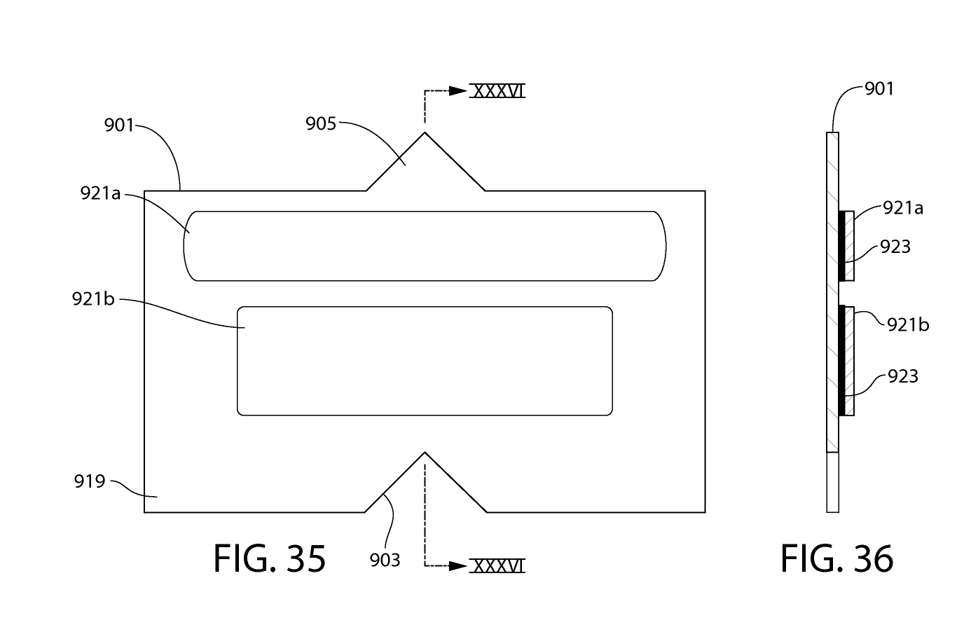

Another embodiment of an oral care strip 901 is shown in FIGS. 35-36. The oral care strip 901 is chiefly rectangular, with a notch 903 formed along one side and a corresponding tab 905 formed along the opposite side. In certain embodiments, the tab 905 and the notch 903 may complementary, with the tab 905 corresponding to the notch 903 in size and shape, so that a plurality of the oral care strips 901 may be placed in an edge-to-edge arrangement. The oral care strip 901 includes a substrate layer 919, two films 921a, 921b affixed thereto, and an oral care composition 923 disposed between each of the films 921a, 921b and the substrate layer 919. The first film 921a is formed having a first geometry, and the second film 921b is formed having a second geometry, with the first and second geometries being different from one another in one or both of size and shape. In certain embodiments, the geometries of the films may be identical. Where oral care strips of different geometries are included, one of the geometries may be configured for application to a user's upper teeth, and the other of the geometries may be configured for application to a user's bottom teeth.

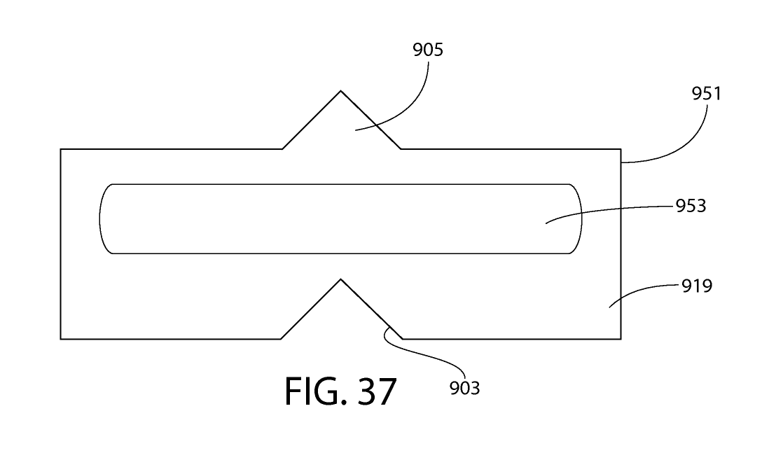

Yet another embodiment of an oral care strip 951 is shown in FIG. 37. The oral care strip 951 is chiefly rectangular, with a notch 903 formed along one side and a corresponding tab 905 formed along the opposite side. In certain embodiments, the tab 905 and the notch 903 may complementary, with the tab 905 corresponding to the notch 903 in size and shape, so that a plurality of the oral care strips 951 may be placed in an edge-to-edge arrangement. The oral care strip 951 includes a substrate layer 919, a film 953 affixed thereto, and an oral care composition (not shown) disposed between the film 953 and the substrate layer 919. The film 953 has a geometry that is different from the geometry of the oral care strip 951. In certain embodiments, the geometry of the film 953 may have any geometry desired, such as a geometry suitable for a user's upper teeth, for a user's bottom teeth, or for a user's front teeth only, and the geometry of the film 953 is not intended to be limiting of the present invention unless so specified in the claims.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

1. A tooth whitening system comprising:
an oral care implement comprising:
a handle comprising an internal cavity and a dispensing aperture forming a passageway into the internal cavity; and
a head comprising at least one oral surface engaging element;
a plurality of tooth whitening strips stored in the internal cavity, each of the plurality of tooth whitening strips comprising at least one film having a tooth whitening composition applied thereto; and
the dispensing aperture configured so that the plurality of tooth whitening strips are removable from the internal cavity via the dispensing aperture.

2. The tooth whitening system according to claim 1 further comprising:
a plurality of sealed packages, each of the plurality of sealed packages containing at least one of the plurality of tooth whitening strips;
the plurality of sealed packages stored in the internal cavity; and
the dispensing aperture configured so that the plurality of sealed packages are removable from the internal cavity via the dispensing aperture.

3. The tooth whitening system according to claim 2 further comprising:
each of the plurality of sealed packages comprising a first package edge and a second package edge opposite the first package edge; and
wherein the plurality of sealed packages are connected to one another in an edge-to-edge arrangement such that the first and second package edges of adjacent ones of the plurality of sealed packages are connected to one another along a pre-weakened line.

4. The tooth whitening system according to claim 3 wherein the plurality of sealed packages are wrapped about one another to form a package roll.

5. The tooth whitening system according to claim 4 wherein the dispensing aperture is configured so that the package roll is removable from the internal cavity via the dispensing aperture in roll form.

6. The tooth whitening system according to claim 4 further comprising:
the dispensing aperture being in the form of an elongated slot that extends along a slot axis;
the package roll having a central axis, the package roll positioned within the internal cavity so that the central axis of the package roll is substantially parallel to the slot axis; and
wherein the plurality of sealed packages can be individually dispensed from the internal cavity via the elongated slot.

7. The tooth whitening system according to claim 2 wherein the plurality of sealed packages are arranged in a stack in the internal cavity, and further comprising:
a feed mechanism in the handle for delivering a top-most one of the plurality of sealed packages in the stack to the dispensing aperture for individual dispensing therefrom; and
an actuator for lifting a portion of the top-most one of the plurality of sealed packages in the stack from the dispensing aperture for grasping by a user.

8.-11. (canceled)

12. The tooth whitening system according to claim 1 further comprising:
each of the plurality of tooth whitening strips comprising a first strip edge and a second strip edge; and
wherein the plurality of tooth whitening strips are connected to one another in an edge-to-edge arrangement such the first and second strip edges of adjacent ones of the plurality of tooth whitening strips are connected to one another along a pre-weakened line;
wherein the plurality of tooth whitening strips are wrapped about one another to form a strip roll;
wherein the dispensing aperture is configured so that the strip roll is removable from the internal cavity via the dispensing aperture in roll form;
the dispensing aperture being in the form of an elongated slot that extends along a slot axis;
the strip roll having a central axis, the strip roll positioned within the internal cavity so that the central axis of the strip roll is substantially parallel to the slot axis; and
wherein the plurality of tooth whitening strips can be individually dispensed from the internal cavity via the elongated slot.

13.-15. (canceled)

16. The tooth whitening system according to claim 12 wherein the oral care implement further comprises an engagement feature adjacent the elongated slot, the engagement feature of the oral care implement configured to engage the plurality of tooth whitening strips at a position adjacent the pre-weakened line between a lead-most tooth whitening strip of the plurality of tooth whitening strips and a next-in-line tooth whitening strip of the plurality of tooth whitening strips during dispensing, thereby prohibiting dispensing of the next-in-line tooth whitening strip from the dispensing aperture and causing the pre-weakened line between the lead-most tooth whitening strip and the next-in-line tooth whitening strip to tear and release the lead-most tooth whitening strip from the strip roll.

17.-19. (canceled)

20. The tooth whitening system according to claim 12 wherein each of the plurality of tooth whitening strips comprises only one film that comprises the first and second strip edges.

21. The tooth whitening system according claim 20 further comprising:
the plurality of tooth whitening strips comprising first tooth whitening strips and second tooth whitening strips, the first and second tooth whitening strips arranged in an alternating manner in the edge-to-edge arrangement;
each of the first tooth whitening strips comprising a first type of the film having first geometry configured for application to a user's upper teeth;
each of the second tooth whitening strips having a second type of the film having a second geometry configured for application to a user's bottom teeth; and
the first and second geometries being different from one another.

22.-24. (canceled)

25. The tooth whitening system according to claim 1 further comprising a cover alterable between: (1) a closed state in which the cover encloses the dispensing aperture; and (2) an open state in which the dispensing aperture is exposed.

26. (canceled)

27. An oral care system comprising:
an oral care implement comprising:
a handle comprising an internal cavity and a dispensing aperture forming a passageway into the internal cavity; and
a head comprising at least one oral surface engaging element;
a plurality of oral care strips stored in the internal cavity, each of the plurality of oral care strips comprising:
a film;
an oral care material associated on the film;
a first strip edge comprising a tab; and
a second strip edge opposite the first strip edge, the second strip edge comprising a notch;
the plurality of oral care strips connected to one another in an edge-to-edge arrangement, the first and second strip edges of adjacent ones of the plurality of oral care strips in the edge-to-edge arrangement connected to one another along a pre-weakened line so that the tab of the first strip edge nests in the notch of the second strip edge; and
the dispensing aperture configured so that the plurality of oral care strips are removable from the internal cavity via the dispensing aperture.

28. (canceled)

29. (canceled)

30. The oral care system according to claim 27 wherein each of the plurality of oral care strips further comprises:
a third strip edge extending between the first and second strip edges;
a fourth strip edge opposite the third strip edge, the fourth strip edge extending between the first and second strip edges;
a longitudinal axis extending between the third and fourth strip edges dividing the oral care strip into a first longitudinal second and a second longitudinal section; an
wherein the notch is located entirely in the second longitudinal section.

31. The oral care system according to claim 27 further comprising:
the plurality of oral care strips comprising first oral care strips and second oral care strips, the first and second oral care strips arranged in an alternating manner in the edge-to-edge arrangement;
each of the first oral care strips comprising a first type of the film having first geometry;
each of the second oral care strips having a second type of the film having a second geometry; and
the first and second geometries being different from one another.

32.-34. (canceled)

35. The oral care system according to claim 27 wherein the plurality of oral care strips are connected to one another in the edge-to-edge arrangement and wrap about one another to form a strip roll, the strip roll positioned within the internal cavity.

36. (canceled)

37. The oral care system according to claim 35 further comprising:
the dispensing aperture being in the form of an elongated slot that extends along a slot axis;
the strip roll having a central axis, the strip roll positioned within the internal cavity so that the central axis of the strip roll is substantially parallel to the slot axis;
the strip roll positioned within the internal cavity so that for each of the plurality of oral care strips the first edge is a lead edge during dispensing; and
wherein the plurality of oral care strips can be individually dispensed from the internal cavity via the elongated slot.

38. The oral care system according to claim 37 wherein the oral care implement further comprises an engagement feature adjacent the elongated slot, the engagement feature of the oral care implement configured to engage the plurality of oral care strips at a position adjacent the pre-weakened line between a lead-most oral care strip of the plurality of oral care strips and a next-in-line oral care strip of the plurality of oral care strips during dispensing, thereby prohibiting dispensing of the next-in-line oral care strip from the dispensing aperture and causing the pre-weakened line between the lead-most oral care strip and the next-in-line oral care strip to tear and release the lead-most oral care strip from the strip roll.

39.-41. (canceled)

42. The oral care system according to claim 27 wherein the oral care material is selected from a group consisting of a tooth whitening composition and a tooth anti-sensitivity composition.

43. A refill for an oral care system comprising:
a plurality of oral care strips, each of the plurality of oral care strips comprising:
a film;
an oral care material on the film;
a first strip edge comprising a tab; and
a second strip edge opposite the first strip edge, the second strip edge comprising a notch; and
the plurality of oral care strips connected to one another in an edge-to-edge arrangement, the first and second strip edges of adjacent ones of the plurality of oral care strips in the edge-to-edge arrangement connected to one another along a pre-weakened line so that tab of the first strip edge nests in the notch of the second strip edge.

44.-50. (canceled)
